(19) United States
(12) Patent Application Publication
(10) Pub. No.: US 2008/0002249 A1
(43) Pub. Date: Jan. 3, 2008

(54) Manufacturing method for the bump refective layer

(75) Inventors: Chien-Chung Kuo, Taichung County (TW); Yi-Fan Chen, Tainan City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/478,673

(22) Filed: Jul. 3, 2006

(51) Int. Cl. G02B 26/00

(52) U.S. Cl. 359/290

(57) ABSTRACT

The present invention is a manufacturing method for a bump reflective layer. The bump reflective layer is used in reflective liquid crystal displays. The manufacturing method is that implanting a plurality of spherical precursors on a substrate, and then coating a cover layer on the substrate. By way of contours of the spherical precursors, the cover layer is made to be lumpy. Finally, depositing a reflective layer on the cover layer. Thus, the manufacture of the bump reflective layer is completed.

### FIELD OF THE INVENTION

The present invention relates to the reflective liquid crystal displays, especially to a manufacturing method for a bump reflective layer that is used in the reflective liquid crystal displays.

### BACKGROUND OF THE INVENTION

Reflective liquid crystal displays use surrounding lights to be the light source for display. Therefore, in contrast with transmissive liquid crystal displays, reflective liquid crystal displays have the electricity-saving superiority. Recently, for increasing the viewing angle of a reflective liquid crystal display, one of the methods is to form a bump reflective layer with lumpy contour on the substrate of the liquid crystal display such that the reflective lights of the incident light can reflect to many directions due to the bump reflective layer so as to improve the viewing angle of the liquid crystal display.

Nowadays, the methods for manufacturing the bump reflective layer generally are the Planarization method and the Half-exposure method. Please refer to FIGS. 1A˜1H, which are the schematic diagrams for the manufacturing procedure of the Planarization method. First of all, manufacturing a thin film transistor (TFT) 2 on a substrate 1, and then coating a layer of photosensitive resin 3 on the substrate 1 with the TFT 2 (as shown in FIG. 1A). Next, after exposing by a photomask 4, the development and bake procedures are executed. Forming a plurality of protrusions 5 on the substrate 1 (as shown in FIGS. 1B˜1D), and then coating a photosensitive resin 6 on the substrate 1 (as shown in FIG. 1E), and using another photomask 7 to execute the exposure and development procedures so as to form a contact hole 8 and reveal the electrode of the TFT 2 through the contact hole 8 (as shown in FIGS. 1F and 1G). Finally, depositing a metal reflective layer 9 (as shown in FIG. 1H), the manufacture of the bump reflective layer 10 is completed.

Please refer to FIGS. 2A˜2F which are the schematic diagrams for the manufacturing procedure of the Half-exposure method. First of all, manufacturing a thin film transistor (TFT) 12 on a substrate 11, and then coating a photosensitive resin layer 13 on the substrate 11 with the TFT 12 (as shown in FIG. 2A). Next, using two different photomasks 14 and 15 to execute two different energy exposures and areas to the photosensitive-resin layer 13 (as shown in FIGS. 2B and 2C). After the development and bake procedures then forming a plurality of protrusions 16 and a contact hole 17 on the substrate 11 (as shown in FIGS. 2D and 2E). Finally, depositing a reflective conductive layer 18 (as shown in FIG. 2F) which contacts with the TFT 12 through the contact hole 17, the manufacture of the bump reflective layer 19 is completed.

The abovementioned two well-known methods use the photolithography to manufacture bump reflective layers. Both the methods need two photomasks and two exposure procedures to complete the manufacture of the bump reflective layers. The Planarization method even extra needs one development procedure and one coating procedure for photosensitive-resin layer. The more manufacturing procedures would be the higher cost. Besides, the cost for the exposure machine and photomasks needed by the photolithography is very expensive, which makes the manufacturing cost for bump reflective layers hard to be reduced.

### SUMMARY OF THE INVENTION

Consequently, the main purpose of the present invention is to provide a manufacturing method for a bump reflective layer, which saves one manufacturing procedure of photolithography such that the manufacturing cost can be reduced.

The present invention is a manufacturing method for a bump reflective layer, which is used to manufacture a bump reflective layer on a substrate. The manufacturing method includes after the procedures of implanting a plurality of spherical precursors on the substrate, coating a cover layer on the substrate, depositing a reflective layer on the protrusion, and then the manufacture of the bump reflective layer being completed. Besides, if the bump reflective layer is used as an electrode, there is an extra procedure that a contact hole should be made on the cover layer for contacting the reflective layer with the TFT on the substrate before depositing the reflective layer such that the manufacture of the electrode-used bump reflective layer is completed.

### BRIEF DESCRIPTION FOR THE DRAWINGS

FIGS. 1A˜1H are the schematic diagrams for the manufacturing procedure of the well-known Planarization method.

FIGS. 2A˜2F are the schematic diagrams for the manufacturing procedure of the well-known Half-exposure method.

FIG. 3 is the manufacturing procedure for the first embodiment example of the present invention.

FIGS. 4A˜4C are the sectional schematic diagrams for each procedure of the first embodiment example of the present invention.

FIG. 5 is the manufacturing procedure for the second embodiment example of the present invention.

FIGS. 6A˜6D are the sectional schematic diagrams for each procedure of the second embodiment example of the present invention.

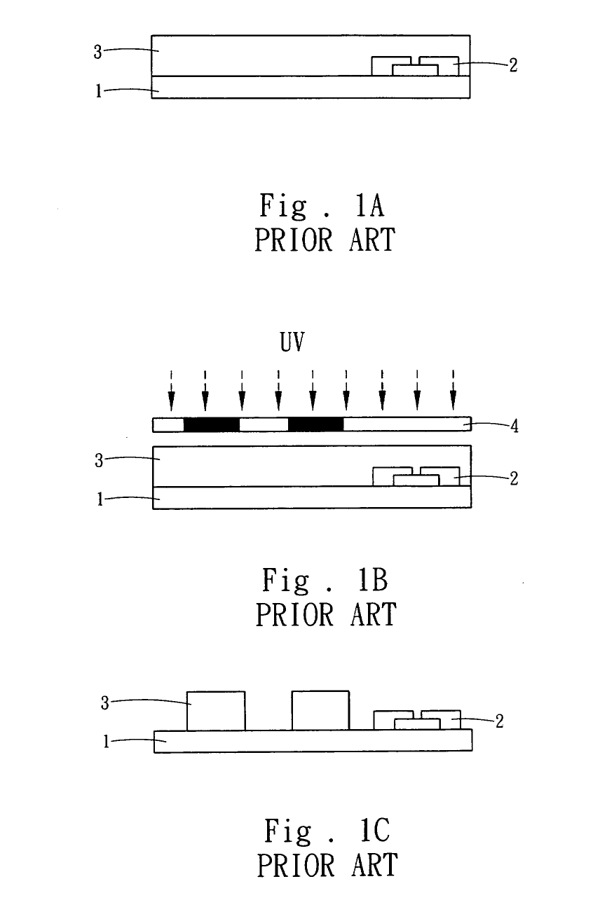

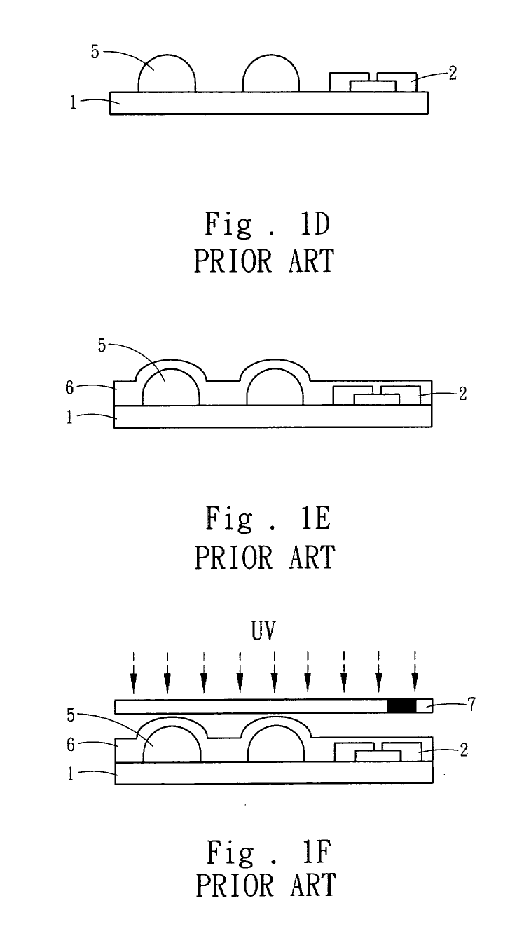

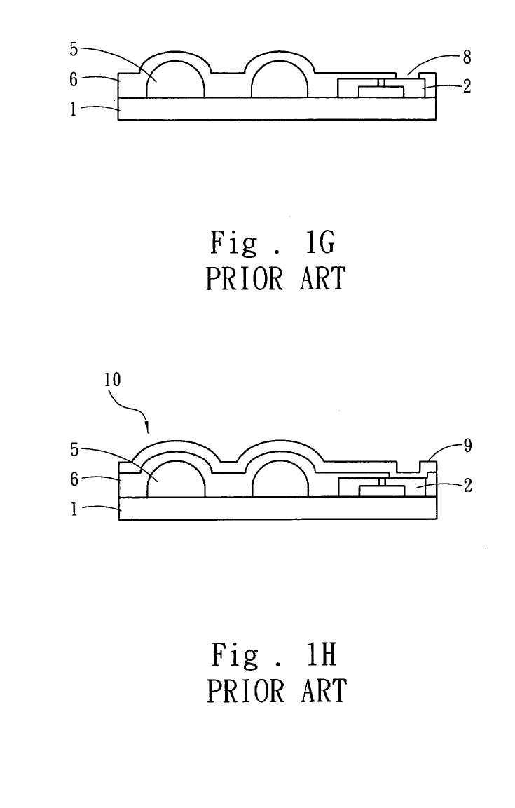

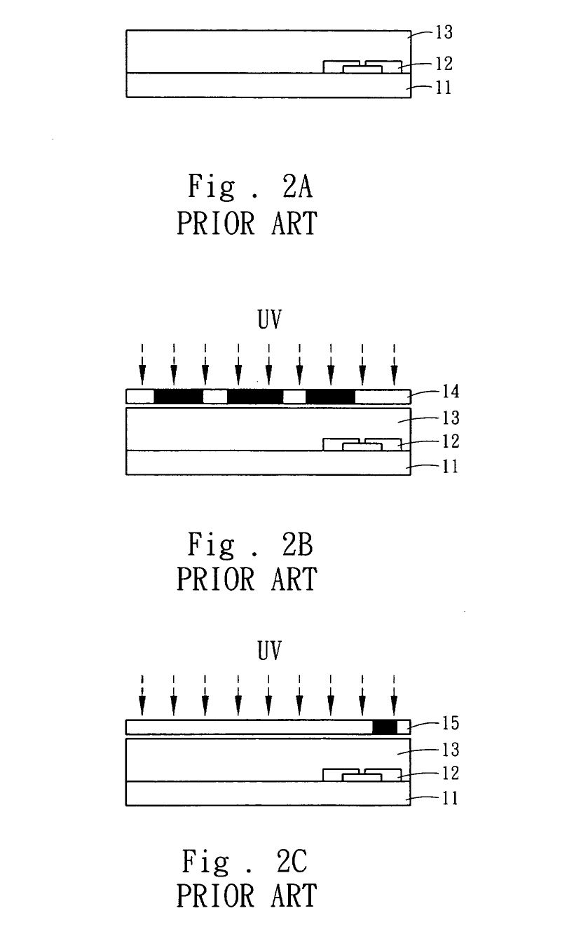

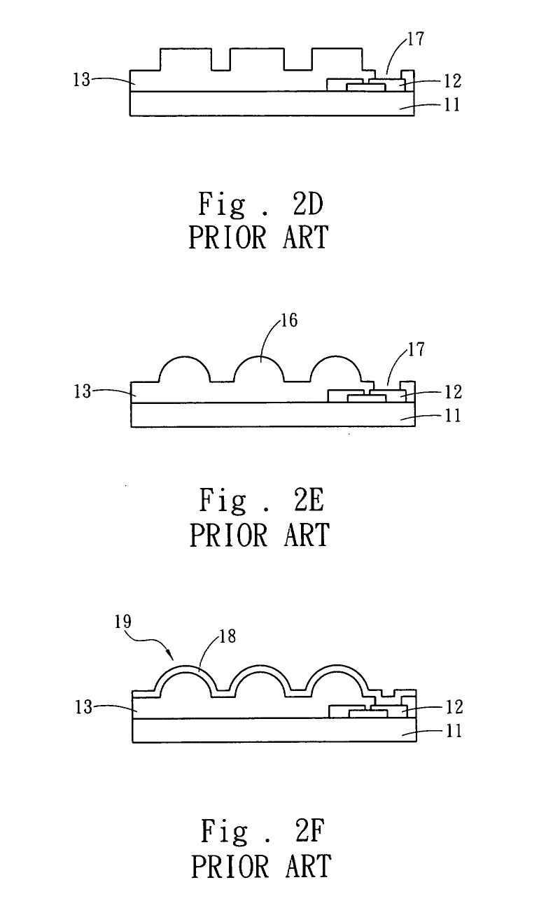

### DETAINED DESCRIPTION OF THE PREFERRED EMBODIMENTS

For reviewers' better understanding of the characteristics, purposes, and functions of the present invention, the detailed descriptions for content and technology of the present invention associate with figures are as follows.

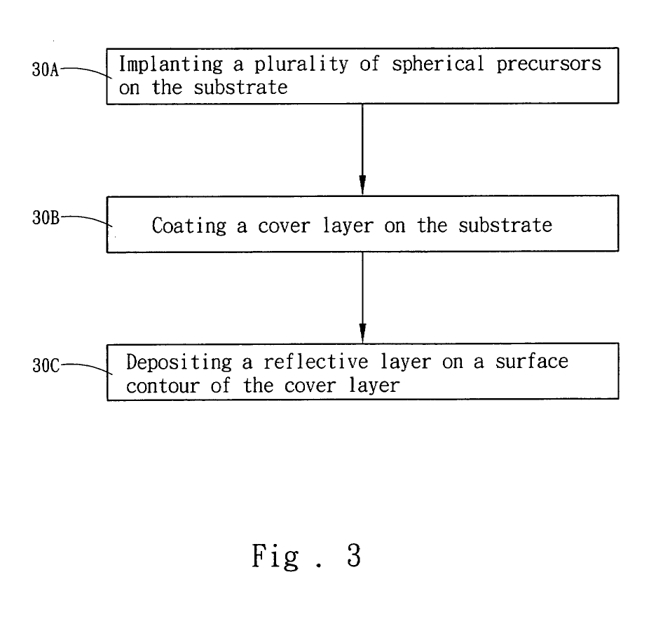

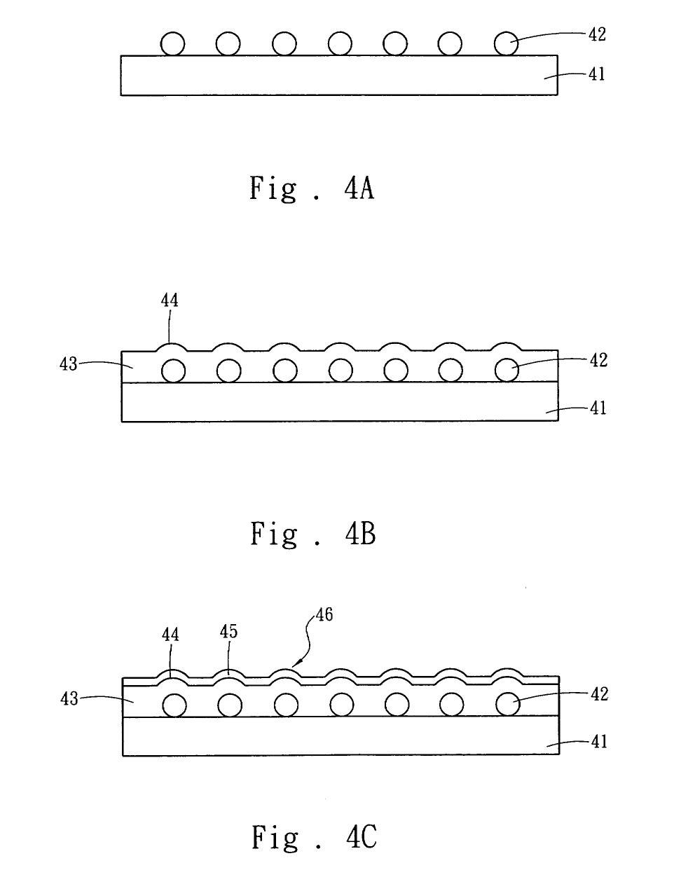

Please refer to FIGS. 3 and 4A˜4C, which illustrate the first embodiment example of the present invention. The manufacturing method includes procedures 30A˜30C. First, the procedure 30A is as shown in FIG. 4A, implanting a plurality of spherical precursors 42 on the substrate 41. The methods for implanting a plurality of spherical precursors 42 on the substrate 41 are wet spray, dry spray, roller sticking, etc. If the wet spray is adopted, the bake procedure is needed after spraying the spherical precursors 42 so as to evaporate the solvent used by the wet spray such that residual solvents are avoided.

Next, the procedure 30B is as shown in FIG. 4B, coating the cover layer 43 on the substrate 41. The coated cover layer 43 has the wrapping effect to the plurality of spherical precursors 42 so the cover layer 43 forms the lumpy surface contour 44 by way of the contour of the spherical precursors 42.

And then, the procedure 30C is as shown in FIG. 4C, depositing the reflective layer 45 on the surface contour 44 of the cover layer 43. The reflective layer 45 has good light-reflection effect. The contour of the reflective layer 45 and the surface contour 44 are the same. The reflective layer 45 has the reflective effect so it can be used as the bump reflective layer 46.

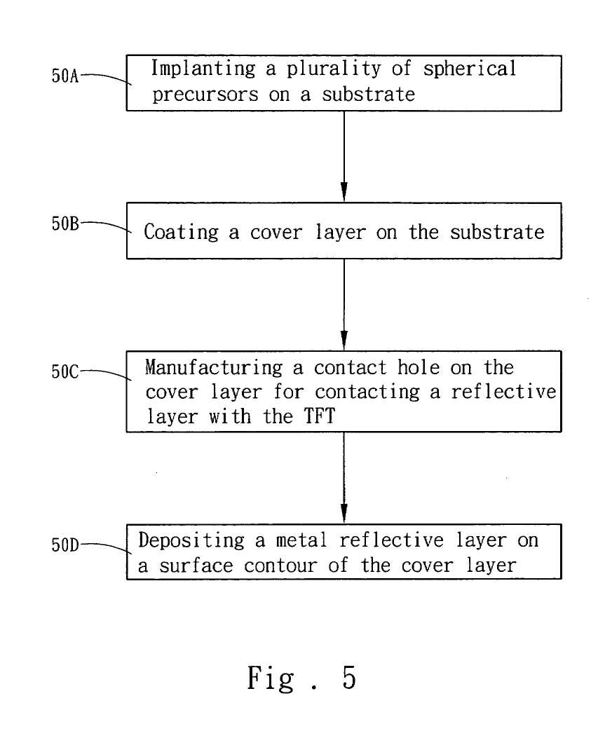

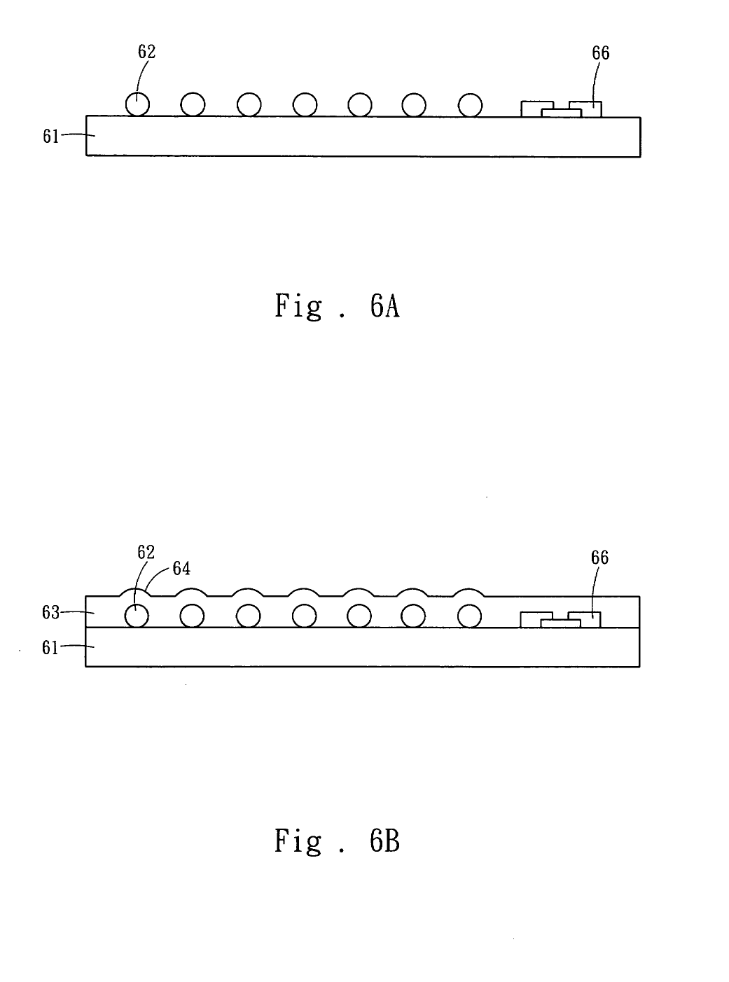

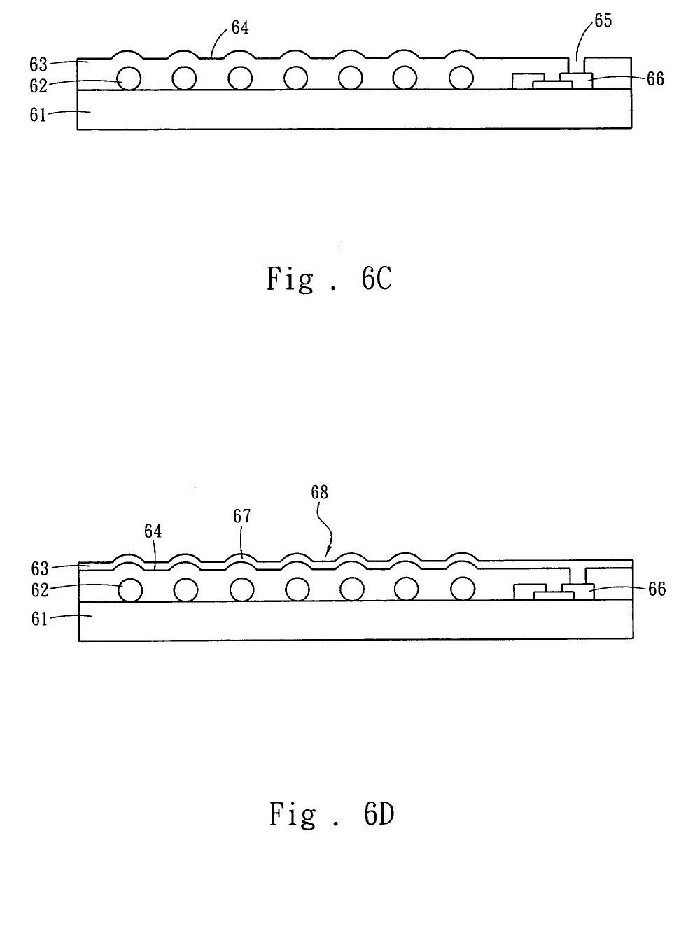

Please refer to FIGS. 5 and 6A˜6D, which illustrate the second embodiment example of the present invention. The manufacturing method includes procedures 50A˜50D. First, the procedure 50A is as shown in FIG. 6A, implanting a plurality of spherical precursors 62 on the substrate 61. Same as the methods illustrated in the first embodiment example, the implanting methods are wet spray, dry spray, roller sticking, etc.

Next, the procedure 50B is as shown in FIG. 6B, coating the cover layer 63 on the substrate 61. The coated cover layer 63 has the wrapping effect to the plurality of spherical precursors 62 so the cover layer 63 forms the lumpy surface contour 64 by way of the contour of the spherical precursors 62.

Then, the procedure 50C is as shown in FIG. 6C, manufacturing a contact hole 65 on the cover layer 63for contacting the reflective layer with the TFT 66. The manufacturing method for the contact hole 65 is related to the material of the cover layer 63. If the material of the cover layer 63 is inorganic, the etching process is used in the photolithography to manufacture the contact hole 65. If the material is photosensitive organic, the development process is used in the photolithography to manufacture the contact hole 65.

The following procedure 50D is as shown in FIG. 6D, depositing the metal reflective layer 67 on the surface contour 64 of the cover layer 63. The metal reflective layer 67 has good light-reflection effect and electric conduction characteristic. The contour of the metal reflective layer 67 and the surface contour 64 are the same, and the metal reflective layer 67 connects to the TFT 66 electrically through the contact hole 65. Therefore, the metal reflective layer 67 has the light-reflection function and also can be used as an electrode, i.e. it can be used as the bump reflective layer 68 with the electrode function.

To sum up, the present invention uses a cover layer to wrap spherical precursors in order to form a lumpy surface contour so as to manufacture the lumpy bump reflective layer. As a result, one photolithography procedure is saved. Accordingly, the present invention can use a lower-cost manufacturing process to replace the high-cost photolithography such that the manufacturing cost can be reduced.

However, the above description is only a better practice example for the current invention, which is not used to limit the practice scope of the invention. All equivalent changes and modifications based on the claimed items of this invention are in the scope of the present invention.

What is claimed is:

1. A manufacturing method for a bump reflective layer; comprising:
implanting a plurality of spherical precursors on a substrate;
coating a cover layer on the substrate, by way of contours of the spherical precursors, the contour of the cover layer being made to be lumpy; and
depositing a reflective layer on the cover layer and thus the manufacture of the bump reflective layer being completed.

2. The manufacturing method as claimed in claim 1, wherein the wet spray is adopted to implant a plurality of spherical precursors on the substrate.

3. The manufacturing method as claimed in claim 2, wherein after the wet spray is adopted to implant a plurality of spherical precursors on the substrate, the bake procedure is needed to remove the solvent used by the wet spray.

4. The manufacturing method as claimed in claim 1, wherein the dry spray is adopted to implant a plurality of spherical precursors on the substrate.

5. The manufacturing method as claimed in claim 1, wherein the roller sticking is adopted to implant a plurality of spherical precursors on the substrate.

6. A manufacturing method for a bump reflective layer, which manufactures a bump reflective layer, and at least one thin film transistor (TFT) installed on the substrate, comprising:
implanting a plurality of spherical precursors on the substrate;
coating a cover layer on the substrate, by way of contours of the spherical precursors, the contour of the cover layer being made to be lumpy;
manufacturing a contact hole on the cover layer, and revealing a electrode of the TFT; and
depositing a metal reflective layer on the surface contour of the cover layer, and the metal reflective layer connecting to the TFT electrically through the contact hole and thus the manufacture of the bump reflective layer being completed.

7. The manufacturing method as claimed in claim 6, wherein the wet spray is adopted to implant a plurality of spherical precursors on the substrate.

8. The manufacturing method as claimed in claim 7, wherein after the wet spray is adopted to implant a plurality of spherical precursors on the substrate, the bake procedure is needed to remove the solvent used by the wet spray.

9. The manufacturing method as claimed in claim 6, wherein the dry spray is adopted to implant a plurality of spherical precursors on the substrate.

10. The manufacturing method as claimed in claim 6, wherein the roller sticking is adopted to implant a plurality of spherical precursors on the substrate.
